(19) United States
(12) Patent Application Publication
(10) Pub. No.: US 2020/0151624 A1
(43) Pub. Date: May 14, 2020

(54) SYSTEMS AND METHODS FOR REMOTE PROVIDER POOL CHECK-IN FOR DYNAMIC TRANSPORTATION NETWORKS

(71) Applicant: Lyft, Inc., San Francisco, CA (US)

(72) Inventors: Lily Sierra, San Francisco, CA (US); Alexander James Hillis, Belmont, CA (US); Ari Greenberg, San Francisco, CA (US); Oleg Vadim Panichev, San Francisco, CA (US); Hicham Bouabdallah, Oakland, CA (US)

(21) Appl. No.: 16/190,057

(22) Filed: Nov. 13, 2018

(51) Int. Cl. G06Q 10/02; G06Q 50/30; G06Q 10/06

(52) U.S. Cl. CPC G06Q 10/02; G06Q 10/06315; G06Q 50/30

(57) ABSTRACT

The disclosed computer-implemented method may include receiving, by a dynamic transportation system, a request from a transportation provider device outside a transportation provider matching area to enter a pool associated with the transportation provider matching area, adding the transportation provider device to the pool in response to receiving the request, thereby rendering the transportation provider device eligible for transportation matches with transportation requests associated with the transportation provider matching area, and matching a transportation request associated with the transportation provider matching area to the transportation provider for the transportation service based at least in part on the adding the transportation provider device to the pool. Other methods, systems, and computer-readable media are disclosed.

### BACKGROUND

Some transportation services may provide transportation on demand, drawing from a transportation provider pool to meet the needs of those requesting transportation services as the needs arise. However, fluctuating demand for transportation services may result in an unacceptable amount of time spent by transportation providers waiting to be matched with transportation requestors, wasted transportation supply resources, a lack of sufficient transportation supply to meet transportation demand, a fluctuation in the level of available transportation providers, or other suboptimal results. For example, a transportation service may experience a fluctuation in transportation requests within areas which have a high concentration of transportation requests resulting in potential delays and inefficiencies in matching transportation providers with transportation requests. The performance of an on-demand transportation service may depend on prompt fulfillment of transportation requests without wasting transportation provider resources. Accordingly, decisions about when and how to fulfill transportation requests may pose costly trade-offs for on-demand transportation services and consumers of on-demand transportation services.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of a pool of transportation providers in an area of high transportation demand.

FIG. 2 is an illustration of a transportation provider reserving a time slot for a transportation match.

FIG. 3 is an illustration of a transportation provider joining a transportation provider pool for a transportation match.

FIG. 4 is an illustration of transportation providers in a physical queueing area within an area of high transportation demand.

FIG. 5 is an illustration of transportation providers in a pool within a transportation provider matching area.

FIG. 6 is a block diagram of an example system for queueing and matching transportation requests in a dynamic transportation network.

FIG. 7 is a graph illustrating an example of transportation services provided by transportation providers over a time period.

FIG. 8 is a flow diagram of an example method for matching transportation requests in a dynamic transportation network based on a priority level.

FIG. 9 is an illustration of an example transportation requestor/transportation provider management environment.

FIG. 10 is an illustration of an example data collection and application management system.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure is generally directed to matching transportation requests (e.g., to a dynamic transportation matching system) to transportation providers using a matching system. Matching decisions between transportation requestors and transportation providers made by a dynamic transportation matching system within areas having a high concentration of transportation demand may pose tradeoffs between maintaining an acceptable level of available transportation providers and managing the amount of time a transportation provider must wait for a transportation match when the number of transportation providers is higher than the number of transportation requests.

Transportation providers may have varying needs and tolerances in terms of the amount of time the transportation provider is willing to wait for a transportation match. In addition, a transportation network may have times of varying transportation demand and a varying supply of transportation providers within areas having a high concentration of transportation demand (e.g., airports, train stations, and other public transportation hubs or event venues). Due to the variations and lack of accurate predictability of transportation provider supply and transportation requestor demand there may be times when transportation providers may wait in a pool until a transportation match is made.

As will be explained in greater detail below, a dynamic transportation matching system that allows transportation providers to check-in to (e.g., enter) a transportation provider pool remotely without having to enter a physical queuing area may provide benefits to transportation providers, transportation requestors, and the dynamic transportation network. The benefits a dynamic transportation matching system allowing remote check-in to the pool may include, without limitation, decreasing the transportation provider wait time in the pool, increasing the transportation provider satisfaction with the transportation service, increasing the number of transportation matches, increasing throughput for each transportation provider, and increasing efficiencies for the dynamic transportation network.

In some examples, the transportation provider pool may be a virtual queue and/or include a virtual queue that includes a group and/or groupings of transportation providers. The transportation provider pool may include a number of transportation providers. The transportation providers in the pool may be associated with a priority level and/or an ordering which may determine the transportation providers position within the virtual queue. The priority level and/or ordering within the pool may determine when the transportation provider is matched.

A dynamic transportation matching system may match transportation provider devices with transportation requestor devices for transportation services by collecting data from multiple sources including, without limitation, transportation provider devices, transportation requestor devices, transportation provider vehicles, external and internal databases, sensors (e.g., traffic, weather, public safety, highway, etc.). The collected data may be associated with the past, present and future movement and locations of transportation provider devices and transportation requestor devices. A dynamic transportation matching system may further use the collected data in generating predicted data. The collected and predicted data may be used by the dynamic transportation matching system to make real-time decisions associated with matching transportation provider devices with transportation requestor devices. The dynamic transportation matching system may continuously collect and predict data in order to maximize the efficiency of matching transportation provider devices with transportation requestor devices.

Accordingly, as may be appreciated, the systems and methods described herein may improve the functioning of a computer that implements remote check-in in dynamic transportation matching. For example, these systems and methods may improve the functioning of the computer by improving dynamic transportation matching results. Additionally or alternatively, these systems and methods may improve the functioning of the computer by reducing the computing resources consumed to identify appropriate transportation matchings (and, e.g., thereby freeing computing resources for other tasks, such as those directly and/or indirectly involved in dynamic transportation matching). In some examples, these systems and methods may improve the functioning of a computer by reducing repeated transportation provider queries from a transportation provider device (e.g., which may otherwise be submitted by potential transportation requestors who would monitor price fluctuations in the absence of a pool).

Furthermore, for the reasons mentioned above and to be discussed in greater detail below, the systems and methods described herein may provide advantages to field of dynamic transportation management and/or the field of transportation. In addition, these systems and methods may provide advantages to vehicles (whether piloted by a human driver or autonomous) that operate as a part of a dynamic transportation network. For example, the vehicles may complete transportation tasks more quickly, more efficiently (e.g., in terms of fuel, vehicle wear, etc.), and/or more safely (e.g., by driving, on average, shorter distances to complete the same transportation objective).

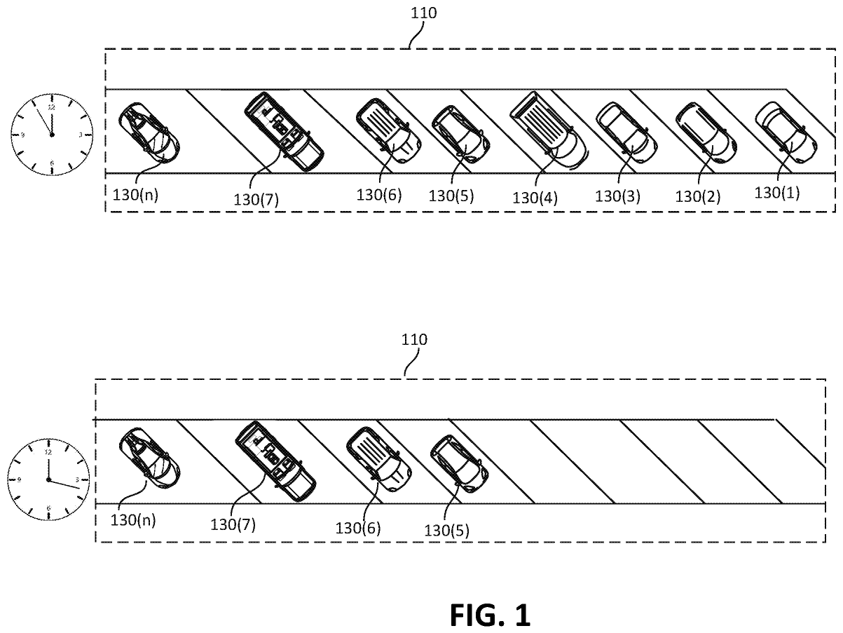

FIG. 1 is an illustration of a pool of transportation providers in an area of high transportation demand. As shown in FIG. 1, pool 110 of transportation providers may include transportation providers 130(1) . . . 130(n). Transportation providers 130(1) . . . 130(n) may be queued in a physical queuing area (e.g., parking lot) near an area which has a high demand for transportation services (e.g., airport, event venue, etc.). In some examples, transportation providers may join a pool when they are at the area of high transportation demand and are available to provide transportation services. Transportation providers 130(1) . . . 130(n) may wait in the physical queuing area until a transportation match is performed by the dynamic transportation matching system and the transportation provider travels to a pick-up area (e.g., airport terminal) to pick up a transportation requestor. Transportation providers 130(1) . . . 130(n) may wait in the physical queuing area for varying amounts of time waiting for a transportation match. In some examples, transportation providers 130(1) . . . 130(n) may wait in the physical queuing area for an excessive amount of time which may contribute to transportation providers 130(1) . . . 130(n) having a dissatisfaction with the dynamic transportation system. Further, an excessive amount of waiting time in the pool may contribute to an inefficiency in the dynamic transportation matching system. An excessive amount of waiting time may depend on a number of transportation requests at any given time, the waiting times may vary and may be so long that it is efficient for the transportation providers to be waiting in the area of high transportation demand for transportation matches as opposed to providing transportation services outside the area of high transportation demand while the transportation providers wait.

In some examples, transportation providers may be removed from the pool by the dynamic transportation matching system when matched to a transportation request. For example, as shown in FIG. 1, transportation providers 130(1) . . . 130(4) may be matched by the dynamic transportation matching system to transportation requests over a period of time and removed from the pool. As a result of removing transportation providers 130(1) . . . 130(4) from the pool, transportation providers 130(5) . . . 130(n) remain in pool 110 waiting for a transportation match.

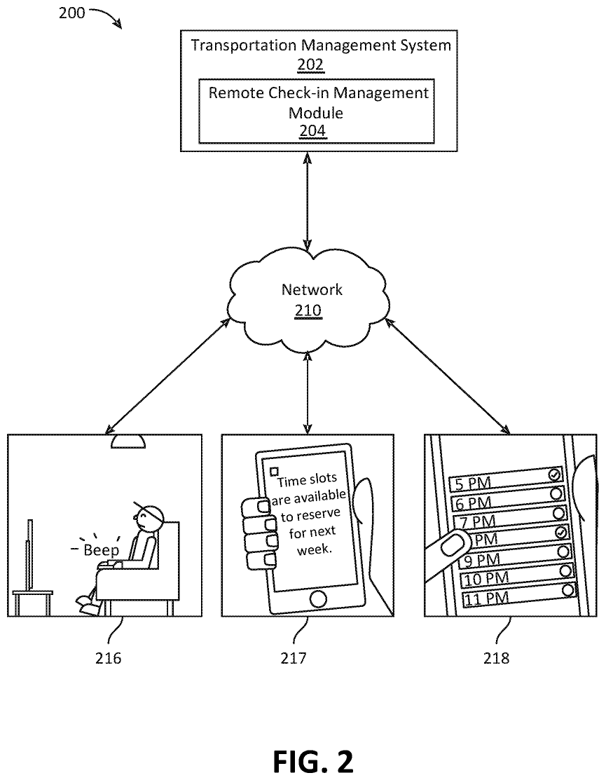

FIG. 2 is an illustration of a transportation provider reserving a time slot for a transportation match in a matching area (e.g., geographic area) having a high demand for transportation services. As shown in FIG. 2, system 200 may allow a transportation provider to reserve a time slot in which the transportation provider is matched to a transportation request. In some examples, a transportation provider may receive a notification 216 that the transportation provider may use system 200 to reserve a time slot. The transportation provider may receive notification 216 on a computing device (e.g., smartphone) over network 210. Transportation management system 202 may include remote check-in management module 204 which may send notification 216 to the transportation provider over network 210 to reserve a time slot. The number of times slots available for transportation providers to reserve may be based on an expected demand for transportation services and/or an expected number of transportation providers which have dropped off a transportation requestor within the matching area and are available for another transportation match. In some examples, the number of time slots available to transportation providers to reserve may be determined by the dynamic transportation matching system and based on the forecasted demand for transportation services less the number of transportation providers forecasted to drop off a transportation requestor within the matching area and are available for another transportation match.

In some examples, transportation matching by the dynamic transportation matching system within the transportation match area may only be available to transportation providers that have a reserved time slot and/or have dropped off a transportation requestor within the matching area and are available for another transportation match.

As described above, remote check-in management module 204 may send notification 216 to the transportation provider over network 210 to reserve a time slot. Notification 216 may be sent by remote check-in management module 204, without limitation, on a daily basis, a weekly basis, or other time period basis. In some examples, message 217 is sent to the transportation provider over network 210 to indicate that time slots are available to reserve for future transportation services. Remote check-in management module 204 may send a message indicating specific future times slots 218 which are available for the transportation provider to reserve. The time slots available for reservation may be, without limitation, on an hourly basis, a half hour basis and/or another time period basis. A transportation provider may reserve time slot(s) by choosing the time slots on a graphical user interface of a computing device (e.g., smartphone).

In some examples, system 200, which allows a transportation provider to reserve a time slot, may be available to all transportation providers within the dynamic transportation network. In some examples, system 200 may only be available to a set of transportation providers having certain characteristics (e.g., transportation providers having a history of dependable performance).

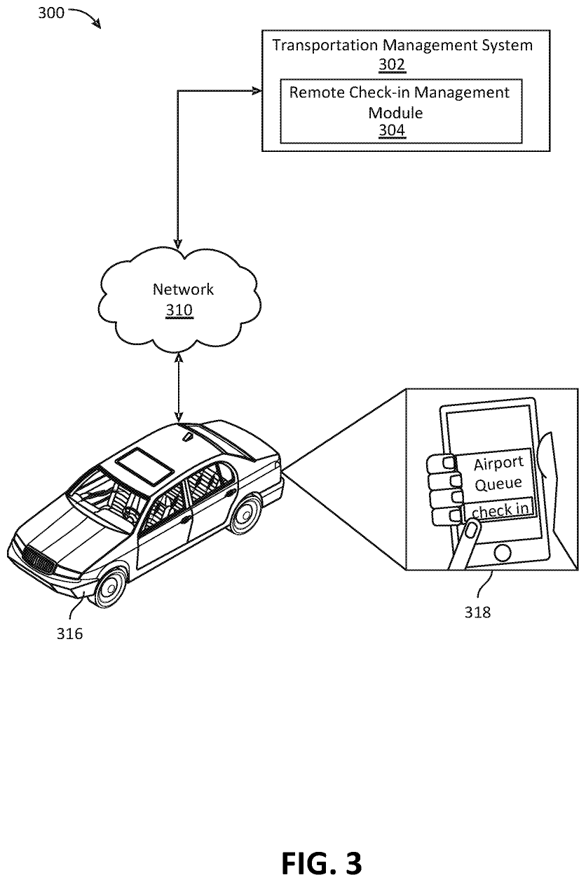

FIG. 3 is an illustration of a transportation provider remotely joining a transportation provider pool for a transportation match. As shown in FIG. 3, system 300 may allow a transportation provider to join a transportation provider pool for a transportation match in which the transportation provider is matched to a transportation request. In some examples, transportation provider 316 may use a graphical user interface on a computing device (e.g., smartphone) 318 to remotely join the transportation provider pool. Transportation management system 302 may include remote check-in management module 304 which may exchange messages with computing device 318 over network 310. Remote check-in management module 304 may exchange messages with computing device 318 to enter transportation provider 316 into the transportation provider pool. The number of transportation providers within the dynamic transportation system which are allowed to remotely join the pool may be based on an expected demand for transportation services and/or an expected number of transportation providers which have dropped off a transportation requestor within the matching area and are available for another transportation match. In some examples, the number of transportation providers which are allowed to remotely join the pool may be based on the forecasted demand for transportation services, less the number of transportation providers forecasted to drop off a transportation requestor within the matching area and are available for another transportation match.

In some examples, transportation matching within the transportation match area may only be available to transportation providers that have a reserved time slot, have remotely checked-in to the pool, and/or have dropped off a transportation requestor within the matching area and are available for another transportation match. Transportation providers that have dropped off a transportation requestor in the transportation matching area may be available for rematch. Otherwise, they may enter the pool with a low priority. In some examples, transportation providers may enter the pool by entering the transportation matching.

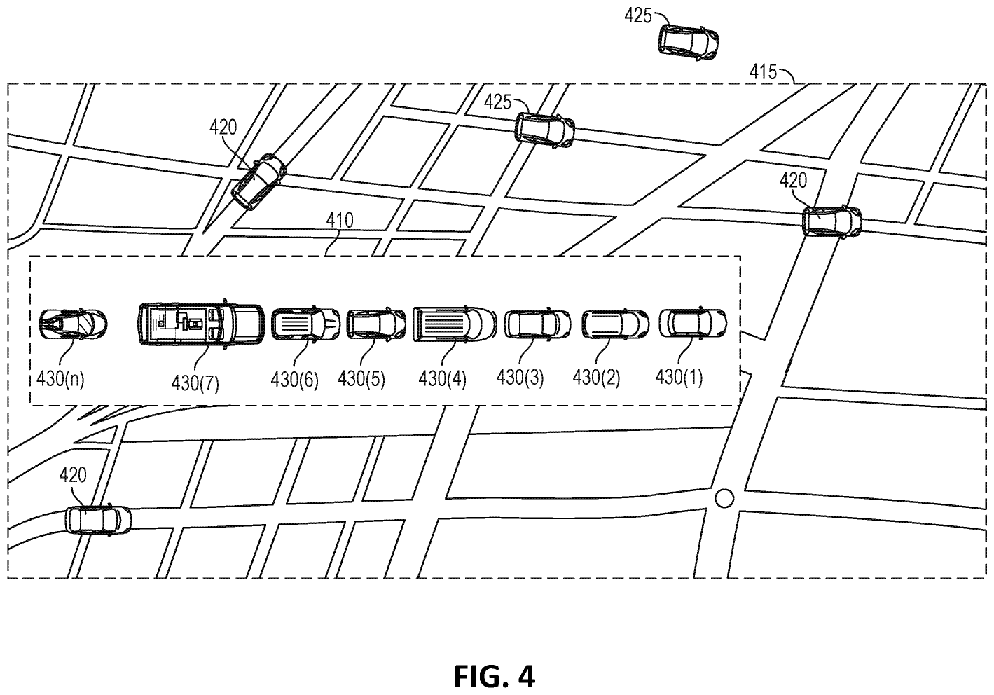

FIG. 4 is an illustration of transportation providers in a physical queueing area within an area of high transportation demand. As shown in FIG. 4, a transportation provider matching area 415 may include a physical queueing area 410 (e.g., parking lot) in proximity to an area of high transportation demand (e.g., airport, event venue, etc.). Physical queueing area 410 may include transportation providers 430(1) . . . 430(n) which are waiting for a transportation match by the dynamic transportation matching system. Although FIG. 4 shows transportation providers 430(1) . . . 430(n) queued in a single line within physical queueing area 410, the present embodiment is not limited to such and transportation providers 430(1) . . . 430(n) may be arbitrarily distributed over physical queueing area 410. Transportation providers 430(1) . . . 430(n) may be assigned a priority level by the dynamic transportation matching system which is associated with a position in the pool. In some examples, transportation provider 430(1) may be assigned a highest priority level and therefore will be matched to the next transportation request within the area of high transportation demand. Transportation provider 430(2) may be assigned the second highest priority level and therefore will be matched to the second transportation request within the area of high transportation demand. The priority levels may decrease for each transportation provider in the pool with transportation provider 430(n) having the lowest priority level. As transportation providers are matched by the dynamic transportation matching system they are removed from the pool and the transportation providers remaining in the pool each have their priority level updated by the dynamic transportation matching system. Transportation provider matching area 415 may have matched transportation providers 420 providing a transportation service after being matched with a transportation request. Transportation provider matching area 415 may also have unmatched transportation providers 425 within transportation provider matching area 415 that may, or may not, be in the pool.

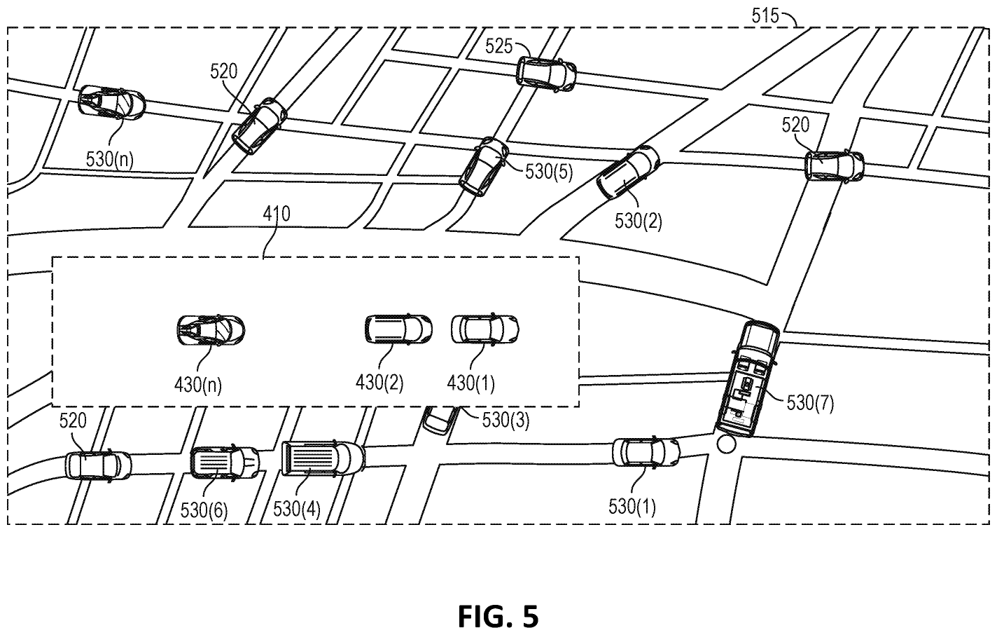

FIG. 5 is an illustration of transportation providers in a pool within a transportation provider matching area. As shown in FIG. 5, a transportation provider matching area 515 may include transportation providers 530(1) . . . 530(n) which are waiting for a transportation match by the dynamic transportation matching system. Transportation providers 530(1) . . . 530(n) may be assigned a priority level which is associated with a position in the pool. In some examples, transportation providers 530(1) . . . 530(n) are in a queue for transportation matching but are not within a physical queueing area (such as physical queueing area 410 of FIG. 4). In some examples, transportation providers 530(1) . . . 530(n) may be pre-dispatched by the dynamic transportation matching system to a physical queueing area such as physical queueing area 410 of FIG. 4 in order to wait for a transportation match. Allowing transportation providers 530(1) . . . 530(n) to enter the pool but not requiring them to wait in a physical queueing area for a substantial amount of time allows transportation providers 530(1) . . . 530(n) to make more efficient use of the waiting time. In some examples, transportation providers may enter the pool by entering the transportation matching. In some examples, a transportation provider may receive a notification from the dynamic transportation matching system indicating the time to begin traveling to physical queueing area 410. Transportation providers 530(1) . . . 530(n) may be allowed to use the waiting time for other activities including, without limitation, providing local transportation services within transportation provider matching area 515 or performing personal activities, thereby increasing the transportation providers satisfaction with the transportation service. Transportation providers 530(1) . . . 530(n) may remain in the pool so long as they remain within transportation provider matching area 515. Transportation provider matching area 515 may be defined, without limitation, by a radius (defined, e.g., by haversine distance, street distance, expected travel time, etc.) from the area of high transportation demand (e.g., airport, event venue, etc.), geohash grid, a geofenced area, a neighborhood, a town, a region or a zip code. In some examples, transportation providers 530(1) . . . 530(n) may remain in the pool and travel outside transportation provider matching area 515 until the estimated match time is close and transportation providers 530(1) . . . 530(n) are pre-dispatched by the dynamic transportation matching system to the area of high transportation demand.

In some examples, transportation provider 530(1) may be assigned a highest priority level by the dynamic transportation matching system and therefore will be matched to the next transportation request within the area of high transportation demand. Transportation provider 530(2) may be assigned the second highest priority level and therefore will be matched to the second transportation request within the area of high transportation demand. The priority levels may decrease for each transportation provider in the pool with transportation provider 530(n) having the lowest priority level. As transportation providers are matched by the dynamic transportation matching system they are removed from the pool and the transportation providers remaining in the pool each have their priority level updated. Transportation provider matching area 515 may have matched transportation providers 520 providing a transportation service after being matched with a transportation request. Transportation provider matching area 515 may also have unmatched transportation providers 525 within transportation provider matching area that are not in the pool.

In some examples, transportation providers may reserve a time slot as described with respect to FIG. 2 or remotely check-in to the pool as described with respect to FIG. 3. A transportation provider that reserves a time slot and/or has remotely checked-in may arrive at physical queueing area 410 and join the pool. However, the transportation provider with a reserved time slot and/or has remotely checked-in may join the pool with an assigned priority level higher than other transportation providers that having been waiting in physical queueing area 410. Reserving a time slot and/or being remotely checked-in results in a shorter wait time in physical queueing area 410 for the transportation provider and increases the transportation provider's satisfaction. In some examples, a transportation provider with a reserved time slot and/or being remotely checked-in may arrive at physical queueing area 410 and be assigned the highest priority level transportation provider 430(1) in the pool. If the transportation provider fails to arrive at physical queueing area 410, the transportation provider may be penalized (e.g., reduction in priority level, etc.) by the dynamic transportation matching system and another transportation provider may be pre-dispatched. In some examples, multiple transportation providers may reserve the same time slot. When multiple transportation providers reserve the same time slot, the priority level assigned to the transportation provider upon arrival at physical queueing area 410 may be based on the arrival time. Transportation providers with a reserved time slot arriving at physical queueing area 410 after other transportation providers with the same reserved time slot may be assigned a lower priority level by the dynamic transportation matching system.

In some examples, a transportation provider that is in proximity to an area of high transportation demand may be arbitrarily chosen by the dynamic transportation matching system and requested to join the pool with a high priority when the number of transportation requests is high. If the transportation provider chooses to join the pool with a high priority, the transportation provider is pre-dispatched by the dynamic transportation matching system from their current location to the area of high transportation demand for a transportation match.

In some examples, transportation providers at physical queueing area 410 without a reserved time slot may have their priority level in the pool decreased as a result of transportation providers with a reserved time slot arriving and being assigned a higher priority level. In some examples, transportation providers with a reserved time slot may have an adjustment of the priority levels. In some examples, the amount of priority level adjustment may be computed by Equation (1) below:

Priority level adjustment amount=average pool wait time in hours*number of check in periods/hour*time slots/check in period (1)

Transportation providers may be provided with an estimated wait time in the pool by the dynamic transportation matching system based on their priority level in the pool and the expected demand for transportation services. A transportation provider's estimated wait time may be adjusted by the dynamic transportation matching system to account for the expected arrival of transportation providers with a reserved time slot and a higher priority. In some examples, the number of transportation providers in the pool seen by other transportation providers may be adjusted.

The priority level in the pool may be based on a status of the transportation provider. In some examples, transportation providers that have recently had their transportation request cancelled and/or recently provided a transportation service over a short distance may have the highest priority level. Transportation providers that pre-scheduled a transportation request may have the second highest priority level. Transportation providers that have reserved a time slot and/or have remotely checked in may have the third highest priority level. Transportation providers that have arrived at physical queueing area 410 may have the fourth highest priority level. Transportation providers arriving at physical queueing area 410 may have their priority level determined based on arrival time with those arriving later having a lower priority level.

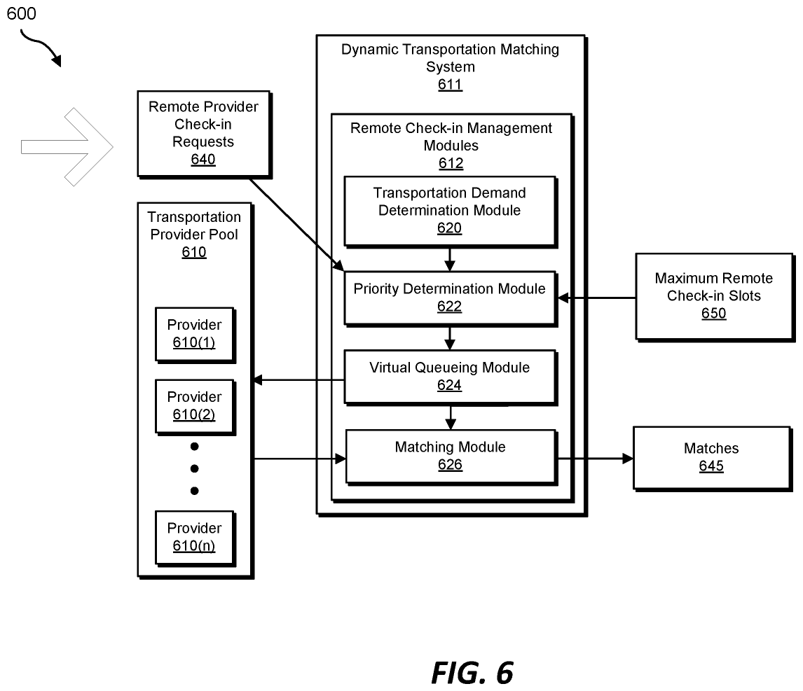

FIG. 6 is a block diagram of an example system for queueing and matching transportation requests in a dynamic transportation network. As shown in FIG. 6, system 600 may include dynamic transportation matching system 611 configured with remote check-in management module 612. In one example, remote check-in management module 612 may include a transportation demand determination module 620, a priority determination module 622, a virtual queueing module 624, and a matching module 626.

As an example, transportation demand determination module 620 may determine the level of demand for transportation services within a transportation provider matching area. The level of demand may be determined for different times periods during a day in which demand for transportation services varies. Transportation providers may provide requests for remote check-in 640 and/or reserved time slot to priority determination module 622. Priority determination module 622 may assign a priority level to transportation providers that have provided requests for remote check-in and may modify the priority level until the transportation provider is matched to a transportation request. Maximum remote check-in slots 650 may provide priority determination module 622 with a maximum number of remote check-in slots that will be accepted. When the maximum number of check-in slots is reached no additional remote check-in requests will be accepted by priority determination module 622. Priority determination module 622 may assign priority levels to transportation providers which have remotely checked into the pool or have entered the pool by entering the physical queuing area. Virtual queuing module 624 may use the priority levels determined by priority determination module 622 to manage transportation provider pool 610. Virtual queuing module 624 may adjust the priority levels of the transportation providers based on any of a variety of factors, including, e.g., their arrival time to the physical queuing area and/or Equation (1) above. In some examples, transportation providers entering the pool may limit the necessity of the system for queueing and matching transportation requests in the dynamic transportation network to identify and match transportation provider resources within a geographic area, thereby decreasing processing, network, and memory resources which are used to identify the best possible transportation matches. Balancing the number of transportation requests and transportation providers in the geographic area may result in more efficient overall operation of the system. As transportation providers are removed from transportation provider pool 610 they are provided to matching module 626 for matching the request to a transportation provider in the pool. Matching module 626 may determine a match between the transportation providers in the pool and the active requests. Matching module 626 may then issue matches 645.

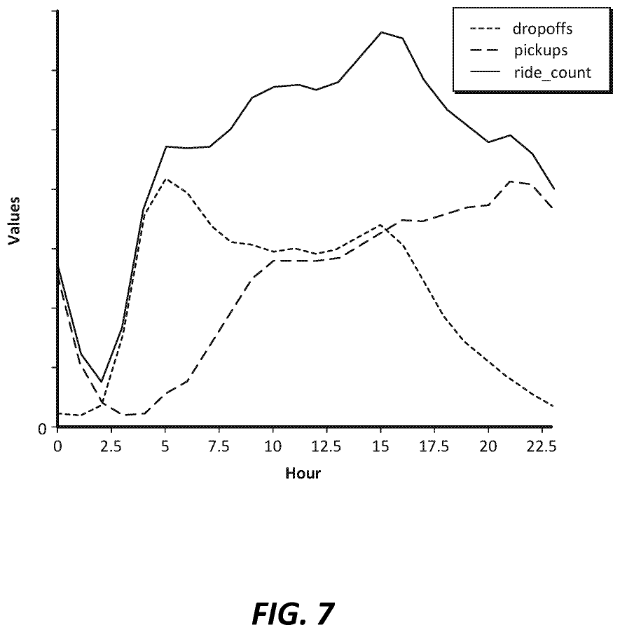

FIG. 7 is a graph illustrating an example of transportation services provided by transportation providers in a dynamic transportation matching system over a time period. FIG. 7 shows a cumulative number of transportation matches within a 24-hour period as measured over 100 days within an area of high transportation demand. The horizontal axis indicates the time of day over the 24-hour period and the vertical axis show the cumulative number of transportation matches. FIG. 7 shows 3 separate graphs indicating the number drop-offs, the number of pickups at the area of high transportation demand and the total number of matches. The graph of FIG. 7 shows that between 3 AM and 9 AM there are significantly more drop-offs than pickups, between 10 AM and 3 PM there is slightly more drop-offs than pickups, and between 3 PM and 2 AM there are significantly more pickups than drop-offs. The time period between 3 PM and 2 AM, in which there are significantly more pickups than drop-offs, is the time period in which the remote pool check-in method of the present disclosure may provide advantages for the dynamic transportation network as it helps to maintain a proper level of transportation providers at areas of high transportation demand while reducing transportation provider wait time.

In one example, a computer-implemented method may include receiving, by a dynamic transportation system, a request from a transportation provider device outside a transportation provider matching area to enter a pool associated with the transportation provider matching area. In some examples, the method may further include increasing a priority level of the transportation provider in the pool for a transportation match, thereby increasing a priority for the transportation match over one or more other transportation providers within the pool. In some examples, the method may further include matching a request to the transportation provider for the transportation service based on the pool.

In some examples, the method may further include reserving, by the transportation provider device, a time slot for the transportation match within the transportation provider matching area.

In some examples, the method may further include receiving, by the transportation provider device, a notification indicating a time of departure for travel to the transportation provider matching area.

In some examples, the method may further include joining, by the transportation provider device, a transportation provider pool for the transportation match within the transportation provider matching area while the transportation provider device is located outside the transportation provider matching area.

In some examples, the transportation provider is removed from the pool when the transportation provider travels outside a second geographic area, and the second geographic area is determined based on an estimated time of arrival to the geographic area.

In some examples, the method further includes receiving, by the transportation provider device, an estimated time of arrival to the geographic area.

In some examples, a supply of transportation requestors is increased in the transportation provider matching area.

In some examples, the transportation provider matching area comprises at least one of an airport or an event venue.

In some examples, the transportation provider is matched to other transportation requests while waiting for the transportation match in the transportation provider matching area.

In some examples, the transportation provider does not wait in a physical queueing area.

In one example, a system may include one or more physical processors and one or more memories coupled to one or more of the physical processors, the one or more memories may include instructions operable when executed by the one or more physical processors to cause the system to perform operations including receiving, by a dynamic transportation system, a request from a transportation provider device outside a transportation provider matching area to increase a priority level of a transportation provider for a transportation match. In some examples, the method may further include increasing the priority level of the transportation provider for the transportation match based upon the request to increase the priority level when the transportation provider is within the transportation provider matching area, thereby increasing a priority for the transportation match over one or more other transportation providers. In some examples, the method may further include matching a transportation requestor to a transportation provider for the transportation service based on the increased priority level.

In some examples, the system may further include reserving, by the transportation provider device, a time slot for the transportation match within the transportation provider matching area.

In some examples, the system may further include receiving, by the transportation provider device, a notification indicating a time of departure for travel to the transportation provider matching area.

In some examples, the system may further include joining, by the transportation provider device, a transportation provider pool for the transportation match within the transportation provider matching area while the transportation provider device is located outside the transportation provider matching area.

In some examples, the transportation provider is removed from the pool when the transportation provider travels outside a second geographic area, and the second geographic area is determined based on an estimated time of arrival to the geographic area.

In some examples, the system further includes receiving, by the transportation provider device, an estimated time of arrival to the geographic area.

In some examples, a supply of transportation requestors is increased in the transportation provider matching area.

In some examples, the transportation provider matching area comprises at least one of an airport or an event venue.

In some examples, the transportation provider is matched to other transportation requests while waiting for the transportation match in the transportation provider matching area.

In some examples, the transportation provider does not wait in a physical queueing area.

In one example, a non-transitory computer-readable storage medium may include computer-readable instructions that, when executed by at least one processor of a computing device, cause the computing device to receive, by a dynamic transportation system, a request from a transportation provider device outside a transportation provider matching area to increase a priority level of a transportation provider for a transportation match. In some examples, the instructions may further cause the computing device to increase the priority level of the transportation provider for the transportation match based upon the request to increase the priority level when the transportation provider is within the transportation provider matching area, thereby increasing a priority for the transportation match over one or more other transportation providers. In some examples, the instructions may further cause the computing device to match a transportation requestor to a transportation provider for the transportation service based on the increased priority level.

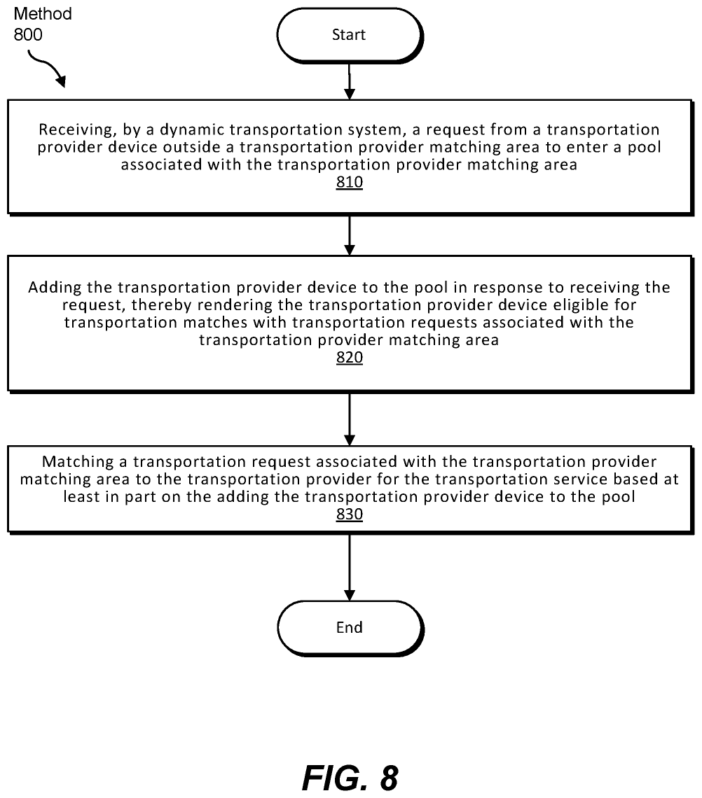

FIG. 8 is a flow diagram of an example method 800 for matching transportation providers to transportation requests in a dynamic transportation network. As shown in FIG. 8, the method may include, at step 810, receiving, by a dynamic transportation system, a request from a transportation provider device outside a transportation provider matching area to enter a pool associated with the transportation provider matching area. At step 820, the method may include adding the transportation provider device to the pool in response to receiving the request, thereby rendering the transportation provider device eligible for transportation matches with transportation requests associated with the transportation provider matching area. At step 830, the method may include matching a transportation request associated with the transportation provider matching area to the transportation provider for the transportation service based at least in part on the adding the transportation provider device to the pool.

Embodiments of the instant disclosure may include or be implemented in conjunction with a dynamic transportation matching system. A transportation matching system may arrange rides on an on-demand and/or ad-hoc basis by, e.g., matching one or more ride requestors with one or more ride providers. For example, a transportation matching system may provide one or more transportation matching services for a ridesharing service, a ridesourcing service, a taxicab service, a car-booking service, an autonomous vehicle service, or some combination and/or derivative thereof. The transportation matching system may include and/or interface with any of a variety of subsystems that may implement, support, and/or improve a transportation matching service. For example, the transportation matching system may include a matching system (e.g., that matches requestors to ride opportunities and/or that arranges for requestors and/or providers to meet), a mapping system, a navigation system (e.g., to help a provider reach a requestor, to help a requestor reach a provider, and/or to help a provider reach a destination), a reputation system (e.g., to rate and/or gauge the trustworthiness of a requestor and/or a provider), a payment system, and/or an autonomous or semi-autonomous driving system. The transportation matching system may be implemented on various platforms, including a requestor-owned mobile device, a computing system installed in a vehicle, a requestor-owned mobile device, a server computer system, or any other hardware platform capable of providing transportation matching services to one or more requestors and/or providers.

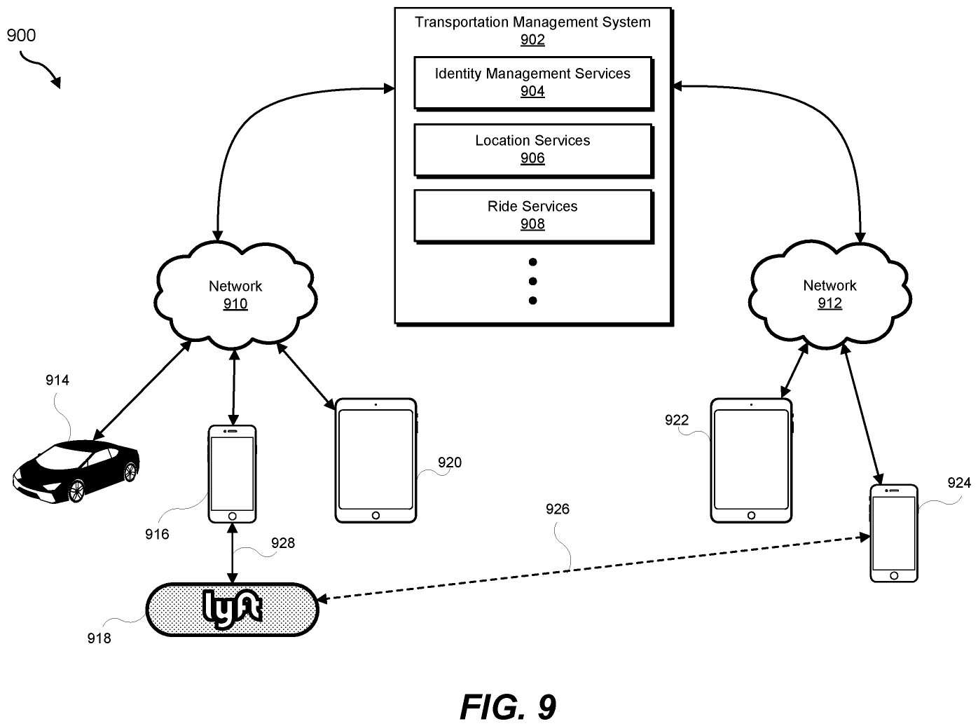

FIG. 9 shows a transportation management environment 900, in accordance with various embodiments. As shown in FIG. 9, a transportation management system 902 may run one or more services and/or software applications, including identity management services 904, location services 906, ride services 908, and/or other services. Although FIG. 9 shows a certain number of services provided by transportation management system 902, more or fewer services may be provided in various implementations. In addition, although FIG. 9 shows these services as being provided by transportation management system 902, all or a portion of any of the services may be processed in a distributed fashion. For example, computations associated with a service task may be performed by a combination of transportation management system 902 (including any number of servers, databases, etc.), one or more devices associated with a provider (e.g., devices integrated with managed vehicles 914, provider's computing devices 916 and tablets 920, and transportation management vehicle devices 918), and/or more or more devices associated with a ride requestor (e.g., the requestor's computing devices 924 and tablets 922). In some embodiments, transportation management system 902 may include one or more general purpose computers, server computers, clustered computing systems, cloud-based computing systems, and/or any other computing systems or arrangements of computing systems. Transportation management system 902 may be configured to run any or all of the services and/or software components described herein. In some embodiments, the transportation management system 902 may include an appropriate operating system and/or various server applications, such as web servers capable of handling hypertext transport protocol (HTTP) requests, file transfer protocol (FTP) servers, database servers, etc.

In some embodiments, identity management services 904 may be configured to perform authorization services for requestors and providers and/or manage their interactions and/or data with transportation management system 902. This may include, e.g., authenticating the identity of providers and determining that they are authorized to provide services through transportation management system 902. Similarly, requestors' identities may be authenticated to determine whether they are authorized to receive the requested services through transportation management system 902. Identity management services 904 may also manage and/or control access to provider and/or requestor data maintained by transportation management system 902, such as driving and/or ride histories, vehicle data, personal data, preferences, usage patterns as a ride provider and/or as a ride requestor, profile pictures, linked third-party accounts (e.g., credentials for music and/or entertainment services, social-networking systems, calendar systems, task-management systems, etc.) and any other associated information. Transportation management system 902 may also manage and/or control access to provider and/or requestor data stored with and/or obtained from third-party systems. For example, a requester or provider may grant transportation management system 902 access to a third-party email, calendar, or task management system (e.g., via the user's credentials). As another example, a requestor or provider may grant, through a mobile device (e.g., 916, 920, 922, or 924), a transportation application associated with transportation management system 902 access to data provided by other applications installed on the mobile device. In some examples, such data may be processed on the client and/or uploaded to transportation management system 902 for processing.

In some embodiments, transportation management system 902 may provide ride services 908, which may include ride matching and/or management services to connect a requestor to a provider. For example, after identity management services module 904 has authenticated the identity a ride requestor, ride services module 908 may attempt to match the requestor with one or more ride providers. In some embodiments, ride services module 908 may identify an appropriate provider using location data obtained from location services module 906. Ride services module 908 may use the location data to identify providers who are geographically close to the requestor (e.g., within a certain threshold distance or travel time) and/or who are otherwise a good match with the requestor. Ride services module 908 may implement matching algorithms that score providers based on, e.g., preferences of providers and requestors; vehicle features, amenities, condition, and/or status; providers' preferred general travel direction and/or route, range of travel, and/or availability; requestors' origination and destination locations, time constraints, and/or vehicle feature needs; and any other pertinent information for matching requestors with providers. In some embodiments, ride services module 908 may use rule-based algorithms and/or machine-learning models for matching requestors and providers.

Transportation management system 902 may communicatively connect to various devices through networks 910 and/or 912. Networks 910 and 912 may include any combination of interconnected networks configured to send and/or receive data communications using various communication protocols and transmission technologies. In some embodiments, networks 910 and/or 912 may include local area networks (LANs), wide-area networks (WANs), and/or the Internet, and may support communication protocols such as transmission control protocol/Internet protocol (TCP/IP), Internet packet exchange (IPX), systems network architecture (SNA), and/or any other suitable network protocols. In some embodiments, data may be transmitted through networks 910 and/or 912 using a mobile network (such as a mobile telephone network, cellular network, satellite network, or other mobile network), a public switched telephone network (PSTN), wired communication protocols (e.g., Universal Serial Bus (USB), Controller Area Network (CAN)), and/or wireless communication protocols (e.g., wireless LAN (WLAN) technologies implementing the IEEE 802.11 family of standards, Bluetooth, Bluetooth Low Energy, Near Field Communication (NFC), Z-Wave, and ZigBee). In various embodiments, networks 910 and/or 912 may include any combination of networks described herein or any other type of network capable of facilitating communication across networks 910 and/or 912.

In some embodiments, transportation management vehicle device 918 may include a provider communication device configured to communicate with users, such as drivers, passengers, pedestrians, and/or other users. In some embodiments, transportation management vehicle device 918 may communicate directly with transportation management system 902 or through another provider computing device, such as provider computing device 916. In some embodiments, a requestor computing device (e.g., device 924) may communicate via a connection 926 directly with transportation management vehicle device 918 via a communication channel and/or connection, such as a peer-to-peer connection, Bluetooth connection, NFC connection, ad hoc wireless network, and/or any other communication channel or connection. Although FIG. 9 shows particular devices communicating with transportation management system 902 over networks 910 and 912, in various embodiments, transportation management system 902 may expose an interface, such as an application programming interface (API) or service provider interface (SPI) to enable various third parties which may serve as an intermediary between end users and transportation management system 902.

In some embodiments, devices within a vehicle may be interconnected. For example, any combination of the following may be communicatively connected: vehicle 914, provider computing device 916, provider tablet 920, transportation management vehicle device 918, requestor computing device 924, requestor tablet 922, and any other device (e.g., smart watch, smart tags, etc.). For example, transportation management vehicle device 918 may be communicatively connected to provider computing device 916 and/or requestor computing device 924. Transportation management vehicle device 918 may establish communicative connections, such as connections 926 and 928, to those devices via any suitable communication technology, including, e.g., WLAN technologies implementing the IEEE 802.11 family of standards, Bluetooth, Bluetooth Low Energy, NFC, Z-Wave, ZigBee, and any other suitable short-range wireless communication technology.

In some embodiments, users may utilize and interface with one or more services provided by the transportation management system 902 using applications executing on their respective computing devices (e.g., 916, 918, 920, and/or a computing device integrated within vehicle 914), which may include mobile devices (e.g., an iPhone®, an iPad®, mobile telephone, tablet computer, a personal digital assistant (PDA)), laptops, wearable devices (e.g., smart watch, smart glasses, head mounted displays, etc.), thin client devices, gaming consoles, and any other computing devices. In some embodiments, vehicle 914 may include a vehicle-integrated computing device, such as a vehicle navigation system, or other computing device integrated with the vehicle itself, such as the management system of an autonomous vehicle. The computing device may run on any suitable operating systems, such as Android®, iOS®, macOS®, Windows®, Linux®, UNIX®, or UNIX®-based or Linux®-based operating systems, or other operating systems. The computing device may further be configured to send and receive data over the Internet, short message service (SMS), email, and various other messaging applications and/or communication protocols. In some embodiments, one or more software applications may be installed on the computing device of a provider or requestor, including an application associated with transportation management system 902. The transportation application may, for example, be distributed by an entity associated with the transportation management system via any distribution channel, such as an online source from which applications may be downloaded. Additional third-party applications unassociated with the transportation management system may also be installed on the computing device. In some embodiments, the transportation application may communicate or share data and resources with one or more of the installed third-party applications.

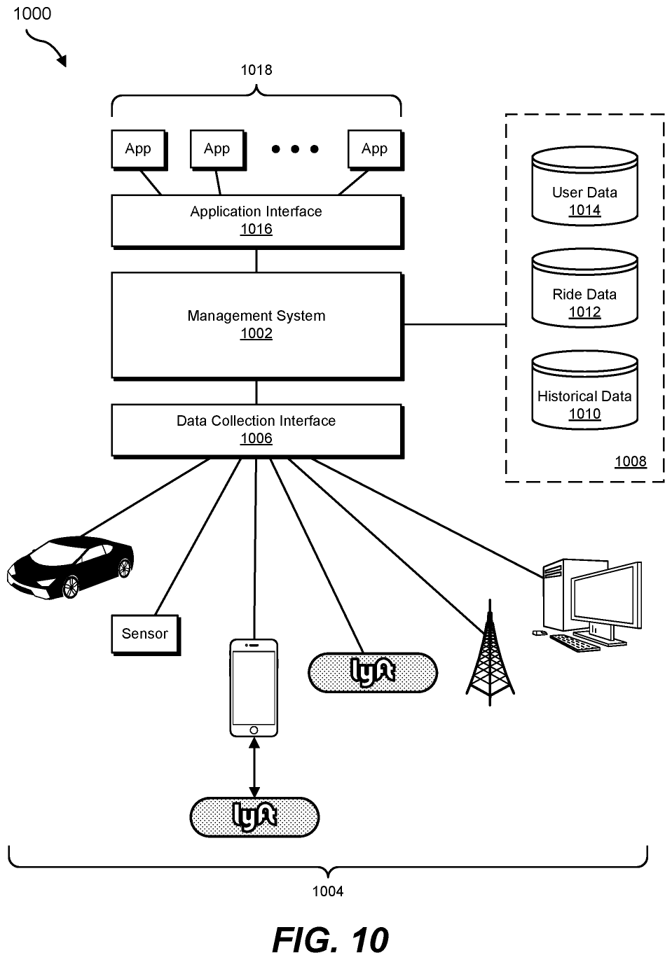

FIG. 10 shows a data collection and application management environment 1000, in accordance with various embodiments. As shown in FIG. 10, management system 1002 may be configured to collect data from various data collection devices 1004 through a data collection interface 1006. As discussed above, management system 1002 may include one or more computers and/or servers or any combination thereof. Data collection devices 1004 may include, but are not limited to, user devices (including provider and requestor computing devices, such as those discussed above), provider communication devices, laptop or desktop computers, vehicle data (e.g., from sensors integrated into or otherwise connected to vehicles), ground-based or satellite-based sources (e.g., location data, traffic data, weather data, etc.), or other sensor data (e.g., roadway embedded sensors, traffic sensors, etc.). Data collection interface 1006 can include, e.g., an extensible device framework configured to support interfaces for each data collection device. In various embodiments, data collection interface 1006 may be extended to support new data collection devices as they are released and/or to update existing interfaces to support changes to existing data collection devices. In various embodiments, data collection devices may communicate with data collection interface 1006 over one or more networks. The networks may include any network or communication protocol as would be recognized by one of ordinary skill in the art, including those networks discussed above.

As shown in FIG. 10, data received from data collection devices 1004 can be stored in data store 1008. Data store 1008 may include one or more data stores, such as databases, object storage systems and services, cloud-based storage services, and other data stores. For example, various data stores may be implemented on a non-transitory storage medium accessible to management system 1002, such as historical data store 1010, ride data store 1012, and user data store 1014. Data stores 1008 can be local to management system 1002, or remote and accessible over a network, such as those networks discussed above or a storage-area network or other networked storage system. In various embodiments, historical data 1010 may include historical traffic data, weather data, request data, road condition data, or any other data for a given region or regions received from various data collection devices. Ride data 1012 may include route data, request data, timing data, and other ride related data, in aggregate and/or by requestor or provider. User data 1014 may include user account data, preferences, location history, and other user-specific data. Although certain data stores are shown by way of example, any data collected and/or stored according to the various embodiments described herein may be stored in data stores 1008.

As shown in FIG. 10, an application interface 1016 can be provided by management system 1002 to enable various apps 1018 to access data and/or services available through management system 1002. Apps 1018 may run on various user devices (including provider and requestor computing devices, such as those discussed above) and/or may include cloud-based or other distributed apps configured to run across various devices (e.g., computers, servers, or combinations thereof). Apps 1018 may include, e.g., aggregation and/or reporting apps which may utilize data 1008 to provide various services (e.g., third-party ride request and management apps). In various embodiments, application interface 1016 can include an API and/or SPI enabling third party development of apps 1018. In some embodiments, application interface 1016 may include a web interface, enabling web-based access to data 1008 and/or services provided by management system 1002. In various embodiments, apps 1018 may run on devices configured to communicate with application interface 1016 over one or more networks. The networks may include any network or communication protocol as would be recognized by one of ordinary skill in the art, including those networks discussed above, in accordance with an embodiment of the present disclosure.

While various embodiments of the present disclosure are described in terms of a ridesharing service in which the ride providers are human drivers operating their own vehicles, in other embodiments, the techniques described herein may also be used in environments in which ride requests are fulfilled using autonomous vehicles. For example, a transportation management system of a ridesharing service may facilitate the fulfillment of ride requests using both human drivers and autonomous vehicles.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, by a dynamic transportation system, a request from a transportation provider device outside a transportation provider matching area to enter a pool associated with the transportation provider matching area;
adding the transportation provider device to the pool in response to receiving the request, thereby rendering the transportation provider device eligible for transportation matches with transportation requests associated with the transportation provider matching area; and
matching a transportation request associated with the transportation provider matching area to the transportation provider device for a transportation service based at least in part on the adding the transportation provider device to the pool.

2. The computer-implemented method of claim 1, wherein:
the pool comprises a virtual queue,
the request from the transportation provider device outside the transportation provider matching area comprises a request to enter the virtual queue, and
the request to enter the virtual queue comprises:
choosing, by the transportation provider device, a time slot; and
increasing a priority for matching the transportation request to the transportation provider when the transportation provider arrives at the transportation provider matching area during the time slot.

3. The computer-implemented method of claim 2, further comprising:
receiving, by the transportation provider device, a notification indicating a time of departure for travel to the transportation provider matching area.

4. The computer-implemented method of claim 2, further comprising:
receiving, by the transportation provider device, an estimated time of arrival to the transportation provider matching area, thereby increasing a probability that the transportation provider arrives at the transportation provider matching area during the time slot.

5. The computer-implemented method of claim 1, further comprising:
entering, by the transportation provider device, the pool associated with the transportation provider matching area while the transportation provider device is located outside the transportation provider matching area.

6. The computer-implemented method of claim 5, wherein:
the transportation provider is removed from the pool when the transportation provider travels outside a second transportation provider matching area,
the second transportation provider matching area surrounds the transportation provider matching area, and
the second transportation provider matching area is determined based on at least one of a distance from the transportation provider matching area and an estimated time of arrival to the transportation provider matching area.

7. The computer-implemented method of claim 1, wherein a number of transportation requestors is increased in the transportation provider matching area thereby increasing an efficiency of the dynamic transportation system.

8. The computer-implemented method of claim 1, wherein the transportation provider matching area comprises an area surrounding at least one of a transportation hub or an event venue.

9. The computer-implemented method of claim 1, further comprising:
determining whether the transportation provider is available to complete a request for transportation service outside the transportation provider matching area while waiting for a transportation match in the transportation provider matching area; and
matching the transportation provider to the request for transportation service outside the transportation provider matching area.

10. The computer-implemented method of claim 1, wherein the transportation provider enters the pool while outside a physical queueing area.

11. A system comprising one or more physical processors and one or more memories coupled to one or more of the physical processors, the one or more memories comprising instructions operable when executed by the one or more physical processors to cause the system to perform operations comprising:
receiving, by a dynamic transportation system, a request from a transportation provider device outside a transportation provider matching area to enter a pool associated with the transportation provider matching area;
adding the transportation provider device to the pool in response to receiving the request, thereby rendering the transportation provider device eligible for transportation matches with transportation requests associated with the transportation provider matching area; and
matching a transportation request associated with the transportation provider matching area to the transportation provider device for a transportation service based at least in part on the adding the transportation provider device to the pool.

12. The system of claim 11, wherein:
the pool comprises a virtual queue,
the request from the transportation provider device outside the transportation provider matching area comprises a request to enter the virtual queue, and
the request to enter the virtual queue comprises:
choosing, by the transportation provider device, a time slot; and
increasing a priority for matching the transportation request to the transportation provider when the transportation provider arrives at the transportation provider matching area during the time slot.

13. The system of claim 12, further comprising:
receiving, by the transportation provider device, a notification indicating a time of departure for travel to the transportation provider matching area.

14. The system of claim 12, further comprising:
receiving, by the transportation provider device, an estimated time of arrival to the transportation provider matching area, thereby increasing a probability that the transportation provider arrives at the transportation provider matching area during the time slot.

15. The system of claim 11, further comprising:
entering, by the transportation provider device, the pool associated with the transportation provider matching area while the transportation provider device is located outside the transportation provider matching area.

16. The system of claim 15, wherein:
the transportation provider is removed from the pool when the transportation provider travels outside a second transportation provider matching area,
the second transportation provider matching area surrounds the transportation provider matching area, and
the second transportation provider matching area is determined based on at least one of a distance from the transportation provider matching area and an estimated time of arrival to the transportation provider matching area.

17. The system of claim 11, wherein a number of transportation requestors is increased in the transportation provider matching area thereby increasing an efficiency of the dynamic transportation system.

18. The system of claim 11, wherein the transportation provider matching area comprises an area surrounding at least one of a transportation hub or an event venue.

19. The system of claim 11, further comprising:
determining whether the transportation provider is available to complete a request for transportation service outside the transportation provider matching area while waiting for a transportation match in the transportation provider matching area; and
matching the transportation provider to the request for transportation service outside the transportation provider matching area.

20. A non-transitory computer-readable storage medium comprising computer-readable instructions that, when executed by at least one processor of a computing device, cause the computing device to:
receive, by a dynamic transportation system, a request from a transportation provider device outside a transportation provider matching area to enter a pool associated with the transportation provider matching area;
add the transportation provider device to the pool in response to receiving the request, thereby rendering the transportation provider device eligible for transportation matches with transportation requests associated with the transportation provider matching area; and
match a transportation request associated with the transportation provider matching area to the transportation provider device for a transportation service based at least in part on the adding the transportation provider device to the pool.
